(19) United States
(12) Patent Application Publication
(10) Pub. No.: US 2013/0097201 A1
(43) Pub. Date: Apr. 18, 2013

(54) QUALITY LEVEL VALUATION SYSTEM AND METHOD

(71) Applicants: Norrine Brydon, New Berlin, WI (US); Susan WILLIAMS, New Berlin, WI (US); Michael SAMSA, New Berlin, WI (US); Guy KOPPERUD, New Berlin, WI (US)

(72) Inventors: Norrine Brydon, New Berlin, WI (US); Susan WILLIAMS, New Berlin, WI (US); Michael SAMSA, New Berlin, WI (US); Guy KOPPERUD, New Berlin, WI (US)

(21) Appl. No.: 13/651,082

(22) Filed: Oct. 12, 2012

Related U.S. Application Data
(60) Provisional application No. 61/547,534, filed on Oct. 14, 2011.

(51) Int. Cl. G06F 17/30

(52) U.S. Cl. CPC G06F 17/30477
USPC 707/769

(57) ABSTRACT

A quality valuation system and method that includes a server system in communication with a user computer over a network and a data repository that stores quality indicator data relating to room quality indicators received from the user computer via the network. The server system includes one or more processors configured to communicate with the user computer through the network to display a webpage using the user computer and to receive the quality indicator data entered into the webpage in response to queries provided by the webpage, determine a quality metric based on the quality data received from the user computer; determine the quality level based on the quality metric, and communicate, through the network, the quality level to the user computer for display via the webpage.

### CROSS REFERENCE TO RELATED APPLICATIONS

The present patent application claims priority to U.S. Provisional Patent Application Ser. No. 61/547,534, filed on Oct. 14, 2011. The entire content of this application is hereby incorporated by reference.

### BACKGROUND OF THE INVENTION

### Field of the Invention

The present invention relates to a system for evaluating quality levels of a room (e.g., bathroom and/or kitchen).

The valuation of quality levels of a room, such as a kitchen or bathroom, for example, for insurance underwriting purposes or other valuation purposes, is typically subjective. An objective, user-friendly system and method are needed.

### SUMMARY

One aspect of the invention provides a quality valuation system that includes a server system in communication with a user computer over a network and a data repository operatively connected to the server system. The data repository stores quality indicator data relating to room quality indicators received from the user computer via the network. The server system includes one or more processors configured to communicate with the user computer through the network to display a webpage using the user computer and to receive the quality indicator data entered into the webpage in response to queries provided by the webpage, determine a quality metric based on the quality data received from the user computer, determine the quality level based on the quality metric, and communicate, through the network, the quality level to the user computer for display via the webpage.

Another aspect provides a method for evaluating a room quality level, the method including communicating, by a server system associated with a data repository, data to a user computer through a network to display a webpage via the user computer and receiving, by the server system, quality indicator data entered into the webpage in response to queries provided by the webpage. The method also includes the steps of determining, by the server system, a quality metric based on the quality data received from the user computer and determining, by the server system, the quality level based on the quality metric. The method further includes the step of communicating, by the server system through the network, the quality level to the user computer for display via the webpage.

Another aspect provides a computer readable non-transitory medium storing computer executable instructions for evaluating a kitchen or bathroom quality level, the instructions when executed configuring one or more processors to communicate, by a server system associated with a data repository, data to a user computer through a network to display a webpage via the user computer; receive, by the server system, quality indicator data entered into the webpage in response to queries provided by the webpage; determine, by the server system, a quality metric based on the quality data received from the user computer; determine, by the server system, the quality level based on the quality metric; and communicate, by the server system through the network, the quality level to the user computer for display via the webpage.

Another aspect provides a computer system for valuating room quality, the system including a processor and a memory including logic instructions, which when executed by the processor, configure the processor to: display a graphical user interface displaying queries relating to room quality indicators; receive quality indicator data relating to room quality indicators entered into the graphical user interface in response to the queries; determine a quality metric based on the quality data; determine the quality level based on the quality metric; and display the quality level on the graphical user interface.

Another aspect provides a computer program product comprising logic instructions stored on a computer-readable medium which, when executed by a computer processor, configure the processor to: display, via a graphical user interface, queries relating to room quality indicators; receive quality indicator data relating to room quality indicators entered into the graphical user interface in response to the queries; determine a quality metric based on the quality data; determine the quality level based on the quality metric; and display the quality level via the graphical user interface.

Another aspect provides a method for evaluating a room quality level, the method including the steps of displaying, by one or more processors of a computer system, queries relating to room quality indicators via a graphical user interface; receiving, by the one or more processors of the computer system, quality indicator data entered into the graphical user interface in response to queries provided by the graphical user interface; determining, by the one or more processors of the computer system, a quality metric based on the quality data; determining, by the one or more processors of the computer system, the quality level based on the quality metric; and displaying, by the one or more processors of the computer system, the quality level via the graphical user interface.

These and other aspects of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment, the structural components illustrated herein can be considered drawn to scale. It is to be expressly understood, however, that the drawings are for the purpose of illustration and description only and are not a limitation of the invention. In addition, it should be appreciated that structural features shown or described in any one embodiment herein can be used in other embodiments as well. As used in the specification and in the claims, the singular form of “a”, “an”, and “the” include plural referents unless the context clearly dictates otherwise.

### BRIEF DESCRIPTION OF THE DRAWINGS

FIG. 1A is a schematic diagram of a quality level valuation system in accordance with an embodiment;

FIG. 1B is a schematic diagram of a quality level valuation system in communication with user computers over a network in accordance with an embodiment;

FIG. 2 is a schematic diagram of a quality level valuation system implemented on a computing device in accordance with another embodiment;

FIG. 3 is a screen shot of an exemplary web page showing kitchen features or accessories displayed in a web browser of the user computer in accordance with an embodiment;

FIG. 4 is a screen shot of an exemplary web page showing kitchen countertop materials displayed in a web browser of the user computer in accordance with an embodiment;

FIG. 5 is a screen shot of an exemplary web page showing kitchen cabinet material displayed in a web browser of the user computer in accordance with an embodiment;

FIG. 6 is a screen shot of an exemplary web page showing a kitchen quality level displayed in a web browser of the user computer in accordance with an embodiment;

FIG. 7 is a screen shot of an exemplary web page showing bathroom sizes displayed in a web browser of the user computer in accordance with an embodiment;

FIG. 8 is a screen shot of an exemplary web page showing bathroom features or accessories displayed in a web browser of the user computer in accordance with an embodiment;

FIG. 9 is a screen shot of an exemplary web page showing bathroom countertop material displayed in a web browser of the user computer in accordance with an embodiment;

FIG. 10 is a screen shot of an exemplary web page showing bathroom cabinet material displayed in a web browser of the user computer in accordance with an embodiment;

FIG. 11 is a screen shot of an exemplary web page showing a bathroom quality level displayed in a web browser of the user computer in accordance with an embodiment;

FIG. 12 is a screen shot of an exemplary web page quality levels of the kitchen and bathrooms displayed in a web browser of the user computer in accordance with an embodiment;

FIG. 13 is a flow chart illustrating a method of valuating a quality level in accordance with an embodiment;

FIG. 14 is a flow chart illustrating a method of valuating a kitchen quality level in accordance with an embodiment;

FIG. 15 is a flow chart illustrating a method of valuating a bathroom quality level in accordance with an embodiment;

FIGS. 16A-16C show tables showing predetermined values associated with kitchen cabinets material, kitchen countertop material, and kitchen features or accessories, respectively, in accordance with an embodiment;

FIG. 17 shows a table used to determine a kitchen quality metric in accordance with an embodiment;

FIG. 18 shows a table used to determine the kitchen quality level in accordance with an embodiment;

FIGS. 19A-19C show tables showing predetermined values associated with bathroom features or accessories, bathroom cabinet material, and bathroom countertop material, in accordance with an embodiment;

FIG. 20 shows a table used to determine a bathroom quality metric in accordance with an embodiment;

FIGS. 21A-21B show tables showing predetermined values associated with bathroom cabinet material and bathroom countertop material, respectively, in accordance with an embodiment;

FIG. 22 shows a table used to determine a bathroom quality metric in accordance with an embodiment;

FIG. 23 shows a table used to determine the bathroom quality level in accordance with an embodiment;

FIG. 24 illustrates a table showing various quality levels of a kitchen;

FIG. 25 illustrates exemplary features of a kitchen having a certain quality level in accordance with an embodiment;

FIG. 26 illustrates other exemplary features of a kitchen having a certain quality level in accordance with an embodiment;

FIG. 27 illustrates other exemplary features of a kitchen having a certain quality level in accordance with an embodiment;

FIG. 28 illustrates other exemplary features of a kitchen having a certain quality level in accordance with an embodiment;

FIG. 29 illustrates other exemplary features of a kitchen having a certain quality level in accordance with an embodiment;

FIG. 30 illustrates other exemplary features of a kitchen having a certain quality level in accordance with an embodiment; and

FIG. 31 illustrates other exemplary features of a kitchen having a certain quality level in accordance with an embodiment.

### DETAILED DESCRIPTION OF THE INVENTION

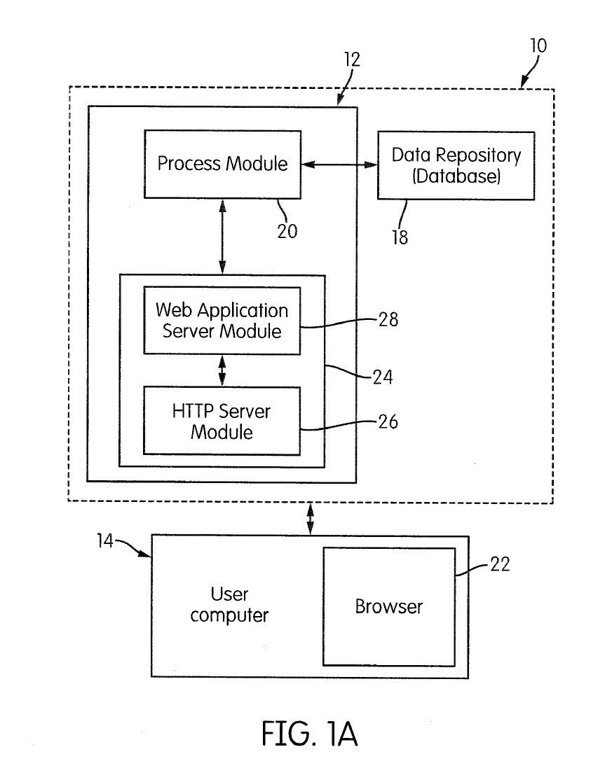

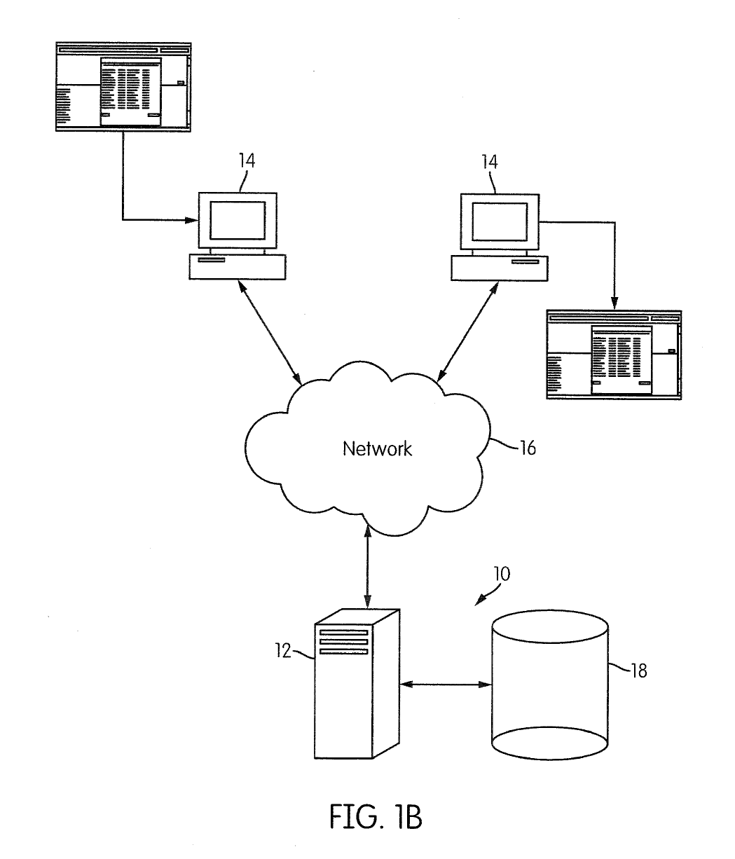

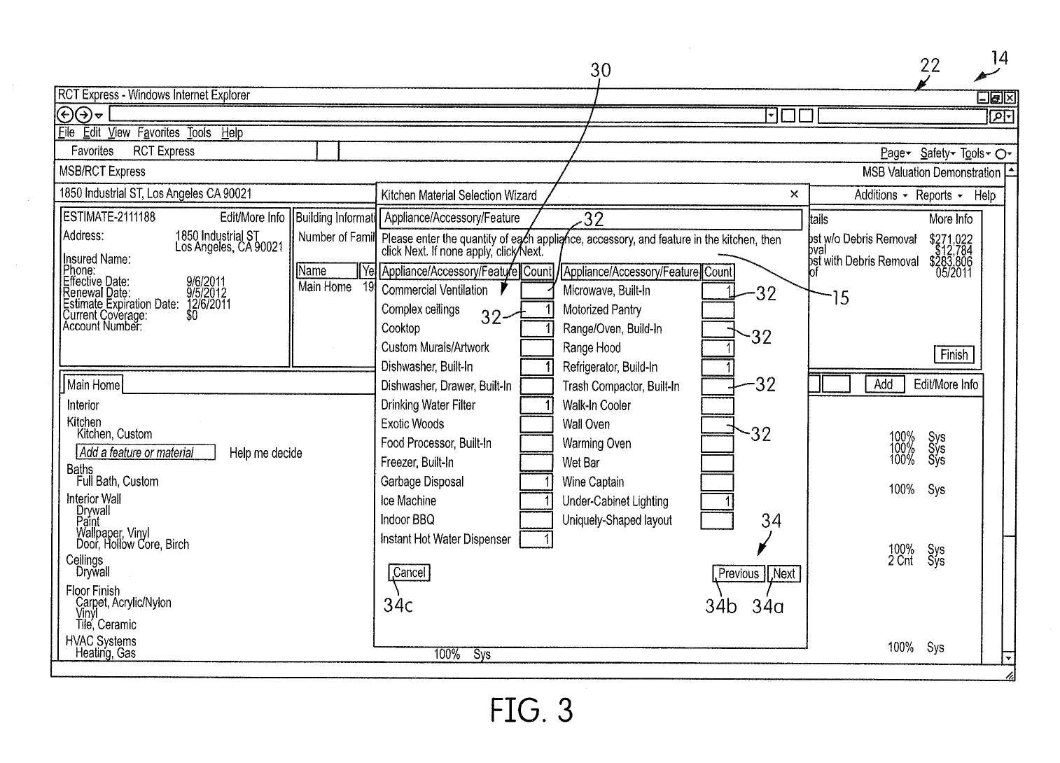

FIG. 1A shows a quality valuation system 10 according to at least one embodiment. The valuation system 10 includes a server 12 in communication with a user computer 14 over a network 16 (see FIG. 1B). The system 10 also includes a data repository or storage 18 that is operatively connected to the server system 12. The data repository 18 may include databases configured to store quality indicator data relating to bathroom or kitchen quality indicators received from the user computer 14 over the network 16. The repository 18 may also store predetermined values associated with the kitchen or bathroom indicators, which will be described in more detail later. Any number of user computers 14 may be connected to the server system 12 over the network 16 (two user computers 14 are shown in FIG. 1B). The server system 12 and the user computer 14 may communicate via the network 16 to provide a webpage 15 (see FIG. 3) to a user using the user computer 14. The user computer 14 may include any type of personal computers, workstations, handheld personal data assistants, smartphones, portable computers, tablet computers, Internet appliances (e.g., an electronic device with display and processing power designed to connect to a network), or any other type of electronic device. The server system 12 may be defined by one server or more servers. Furthermore, the data repository 18 may include any number of databases. It should also be appreciated that the system 10 may also include other memory for storing information used in the valuation of quality levels.

The user computer 14 may provide a browser 22 that enables a user to interact with the quality valuation system 10. A user interface device (e.g., keyboard, mouse, touch pad) may be connected to the user computer 14 to enable a user to input data into the user computer 14. The browser 22 may be connected to the system 10 via a front end system 24 that includes a web server module 26, taking the form of an http server module in this embodiment, and a web application server module 28. The web server module 26 may be configured to generate and output interactive pages to the user computer 14 using the World Wide Web for display using the web browser 22. The web application server module 28 may be configured to run one or more web based application programs (e.g., an application program to implement the methods of evaluating the quality level as described herein). For example, the web application server module 28 may be configured to execute one or more web based application programs, responsive to commands and data received from the users via a web page supported by the web server 26, and provide data and results to the users. The web server module 26 and the web application server module 28 may be implemented using a single computing platform. Alternatively, they may also be implemented using separate computing platforms. In some embodiments, the web server module 26, the web application server module 28, and the process module 20 may be implemented all on a single computing platform. Furthermore, in some embodiments, the process module 20 may be included in the web application server module 28. In other embodiments, the web application server module 28 may be separate from the process module 20 and may communicate with the process module 20 such that data processed by the process module 20 may be communicated to the web application server module 28 and to the web server 26 for display on the web browser 22 of the user computer 14. In some embodiments, the process module 20 may be part of a back end of the system 10. Other modules or components may be included in the server system 12. Furthermore, some of the modules shown in FIG. 1A may be eliminated in other embodiments. As mentioned above, the server system 12 may also be defined by any number of servers and may include any number and type of computing platforms.

Referring back to FIG. 1A, the server system 12 may include a process module 20 configured to process data. The process module 20 may be defined by any number and combination of processors. It should also be appreciated that the processors may be implemented as a general purpose microprocessor, for example, in a central processing unit, a micro controller, or other similar device. The process module 20 may fetch the instructions, decode them, and act or instruct other elements to, for example, transfer data to or from the data repository 18 or to work in combination with the user interface device or the display of the user computer 14 (for example, to input or output data), etc. Furthermore, the process module 20 may be configured to run sequences of programmed instructions to carry out the valuation of quality levels. The instructions may include software instructions that may be implemented using, for example, JavaScript. Other implementations are possible. For example, the process module 20 may run applications that are implemented using programmed instructions in accordance with the C++, Visual Basic, JavaScript programming languages, other programming languages, or any combination thereof. The server system 12 may thereby be configured, using a sequence of programming instructions, for example, to evaluate the quality levels as described herein. The applications run by the process module 20 may also include sequences of database access scripts to effect storage and retrieval of event data stored in a database of the data repository 18. These database access scripts may, for example, be implemented in the form of SQL scripts.

The network 16 may represent a generic network, which may correspond to a Local Area Network (LAN), a Wide Area Network (WAN), the Internet, a proprietary network, a telephone network, a wireless network, or other types of networks. Depending on the nature of the network employed for a particular application, the network 16 may be implemented accordingly. The network 16 may serve the purpose of delivering information between connected parties.

The server system 12 may receive commands and data from the user computers 14 and output program code and data to the user computers 14 using the network 16. In an embodiment, the server system 12 may generate and transmit the requested information to the user computer 14 via Hypertext Transfer Markup Language (HTML) formatted or eXtensible Markup Language (XML) formatted pages, which may be provided as World Wide Web pages, using the network 16. As described previously, the network 16 may be, for example, a network of interconnected networks such as the Internet, a LAN, a WAN, an intranet including any of these, and/or the PSTN. Interactive pages transmitted and received using the network 16 may conform to the SSL protocol. The pages may then be displayed using the web browser 22. The web browser 22 displays data and is capable of communicating with other computers via a network such as, for example, the Internet or an intranet. The web browser 22 provides a user with a way to navigate, via, for example, hyperlinks which are inputted by the user using the user interface device. The web browser 22 uses a protocol such as, for example, HTTP or File. Transfer Protocol (FTP), to transmit data of various content such as, for example, HTML formatted documents, plain text documents, graphic images, and XML documents for presentation to the user using the user computer 14. Web pages formatted in accordance with HTML or XML may also be provided in accordance with the eXtensible Style Language (XSL) specification available from the World Wide Web Consortium. The web browser 22 may also run or execute programs, such as Java applets including sequences of instructions provided in accordance with the Java programming language, or JavaScript. The web browser 22 may be, for example, Internet Explorer® by Microsoft Corporation®, Netscape Navigator® by Netscape®, America Online® browser, or any other web browser.

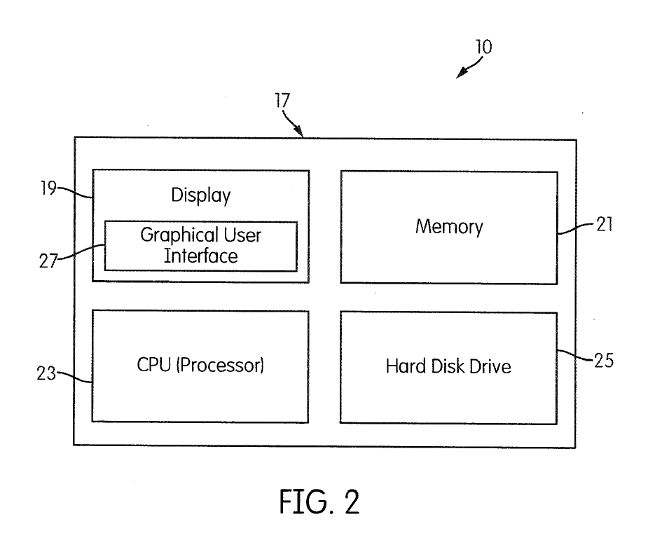

FIG. 2 shows the quality valuation system 10 implemented on a computer system 17 in accordance with another embodiment. The computer system 17 may include any device capable of processing information and displaying information. The computer system 17 may include any computing device, such as personal computers, workstations, handheld personal data assistants, smartphones, portable computers, tablet computers, Internet appliances (e.g., an electronic device with display and processing power designed to connect to a network), or any other type of electronic device. In this embodiment, the quality valuation system 10 is implemented locally on the computing device rather than over a network. The system 17 includes a CPU (Central Processing Unit) or processor 23 connected to a memory 21 which may include one or both nonvolatile or volatile memory (e.g., Read Only Memory or Random Access Memory). The system 17 also includes a display 19 configured to display a graphical user interface 27 and a hard disk drive 25. It should be appreciated that the system 17 may include additional components. In one embodiment, the hard disk drive 25 may store a base program (operating system) and various application programs. When the system 17 starts up, the CPU 23 may read the base program from the hard disk drive 25 and execute the base program in the memory 21. Accordingly, the CPU 23 may be configured to display the graphical user interface 27 displaying queries relating to room quality indicators and receive quality indicator data relating to room quality indicators entered into the graphical user interface 27 in response to the queries. The CPU 23 may determine a quality metric based on the quality data and determine the quality level based on the quality metric. The CPU 23 running the program may display the quality level on the graphical user interface 27 provided by the display 19.

FIG. 3 shows a screenshot of a webpage 15 displayed on the web browser 22 of the user computer 14 for the valuation of a kitchen quality level. In some embodiments, the webpage 15 may be displayed in a popup window of the browser 22. In this embodiment, the webpage 15 includes queries 30 associated with kitchen quality indicators. For example, in FIG. 3, the queries 30 relate to the appliances or features present in a kitchen. Each appliance or feature or the number of each appliance and/or features may be a quality indicator. The webpage 15 includes input fields 32 configured to enable users to input information therein using the user interface device. In this embodiment, each appliance or feature includes an input field 32 associated therewith. Buttons 34 may be provided on the webpage 15 and configured to enable a user to select an input, such as a request to move on to the next page. In this embodiment, the user may click on the button 34a using the user interface device to transmit the data entered into the input fields 32 to the server system 12 via the network 16 and to view different content on the web page 15. Button 34c may be selected to close the webpage 15. It should be appreciated that in embodiments where the quality valuation system 10 is implemented locally on a system 17, the graphical user interface 27 displayed on the display 19 may have similar contents as the webpages 15 described herein. Thus, the contents displayed by the webpages 15 are not limited to webpages displayed using the browsers 22 and instead may be displayed on various types of graphical user interfaces, such as the graphical user interface 27 of the system 17.

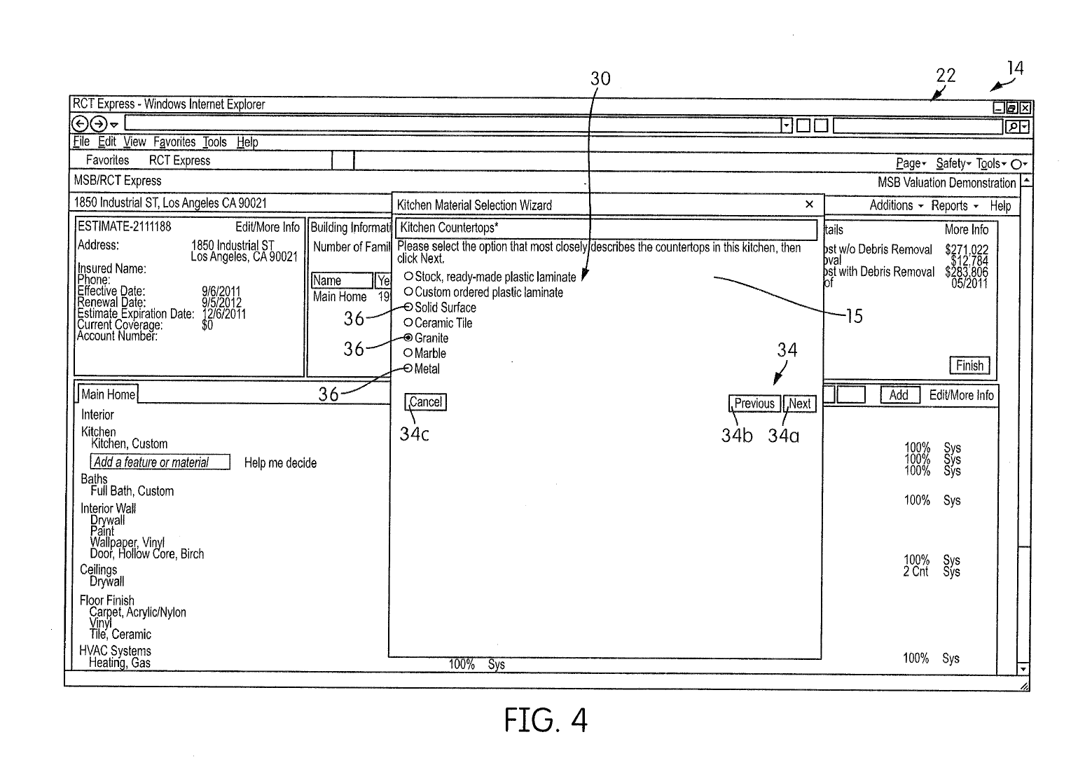

FIG. 4 shows a screenshot of the webpage 15 displaying queries 30 associated with countertop material. In this embodiment, each material may be a quality indicator. In this embodiment, the webpage 15 includes a radio button 36 associated with each countertop material. However, it should be appreciated other input fields or types may be used. It should also be appreciated that the type of materials listed may vary in other embodiments. The button 34b may be selected to view the webpage 15 with the contents shown in FIG. 4.

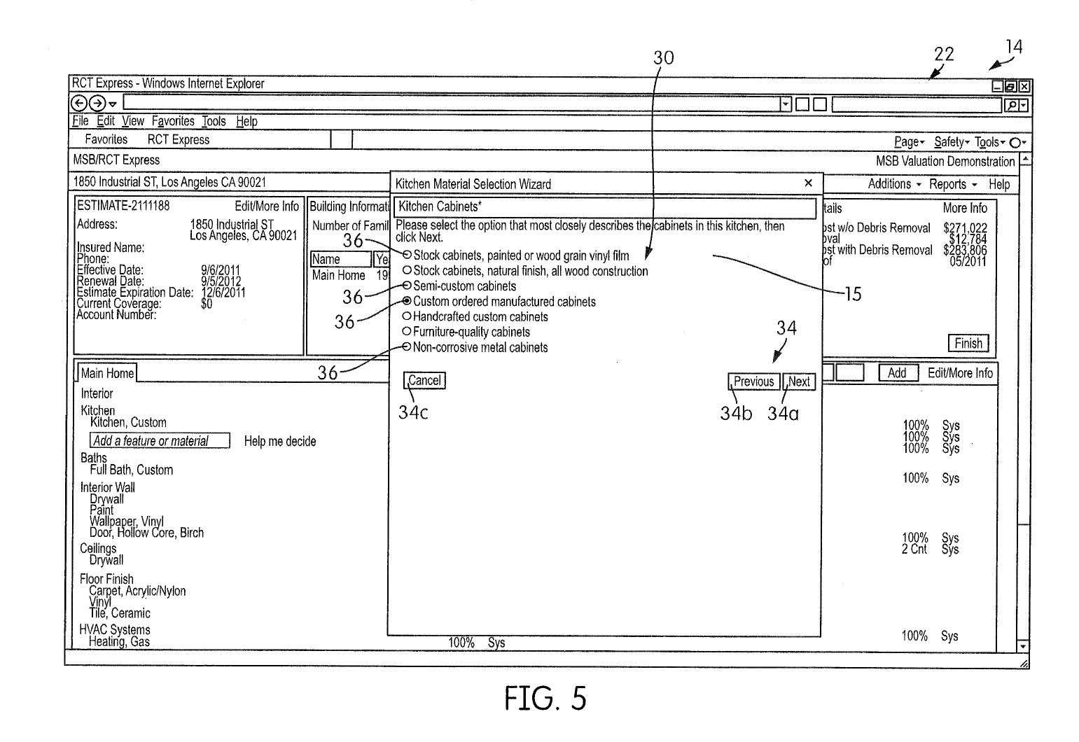

FIG. 5 shows a screenshot of the webpage 15 displaying queries associated with cabinet material. In this embodiment, each material may be a quality indicator. In this embodiment, the webpage 15 includes a radio button 36 associated with each cabinet material. However, it should be appreciated other input fields or types may be used. It should also be appreciated that the type of materials listed may vary in other embodiments. The button 34b may be selected to view the webpage 15 with the contents shown in FIG. 4.

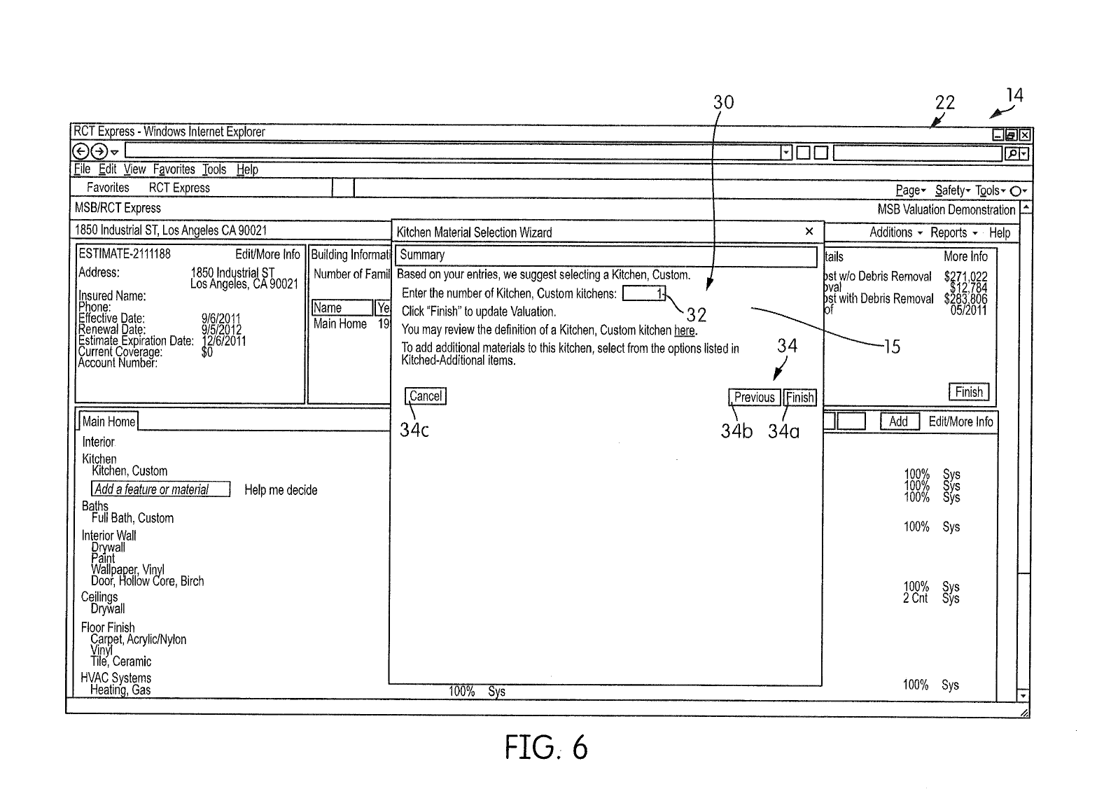

FIG. 6 shows a screenshot of the webpage 15 displaying the quantity level of the kitchen based on the quality indicators entered by the user in the webpages 15 shown in FIGS. 3-5. The quality level may be determined by the server system 12 based on the kitchen quality data received from the user computer 14. The quality level may be transmitted to the user computer 14 via the network 16 for display on the webpage 15, which will be described in more detail later. FIG. 6 includes an input field 32 wherein a user may enter the number of kitchens having the quality level. The button 34b may be selected to view the webpage 15 with the contents shown in FIG. 5. A link may be provided such that selection of the link effects the information or details of the quality level to be displayed via the web browser 22. The information or details may be transmitted from the server system 12 to the user computer 12 for display using the web browser 22.

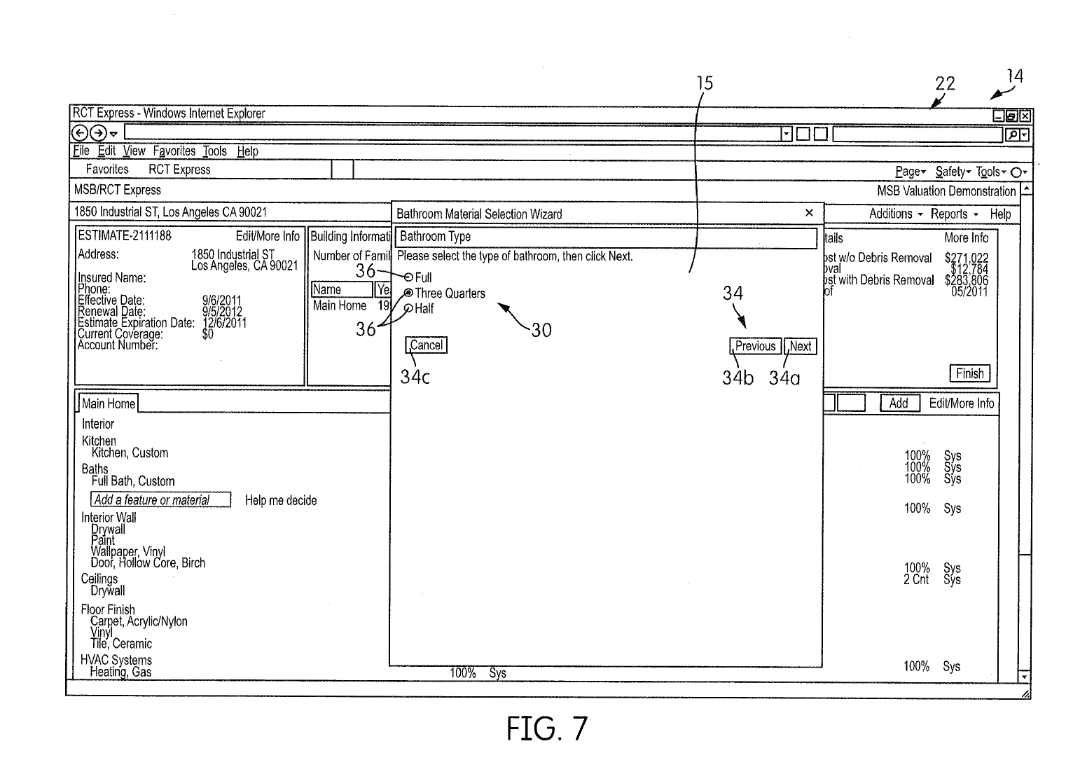

FIG. 7 shows a screenshot of a webpage 15 displayed on the web browser 22 of the user computer 14 for the valuation of a bathroom quality level. In this embodiment, the quality indicators are associated with the size of the bathroom. Accordingly, the queries 30 relate to the size of the bathrooms and each radio button 36 is associated with a size. However, it should be appreciated other input fields or types may be used. As mentioned above, the button 34a may be selected by the user to transmit the quality indicator data entered using the radio button 36 to the server system 12 via the network 16 and to view different contents on the webpage 15. Button 34c may be selected to close the webpage 15.

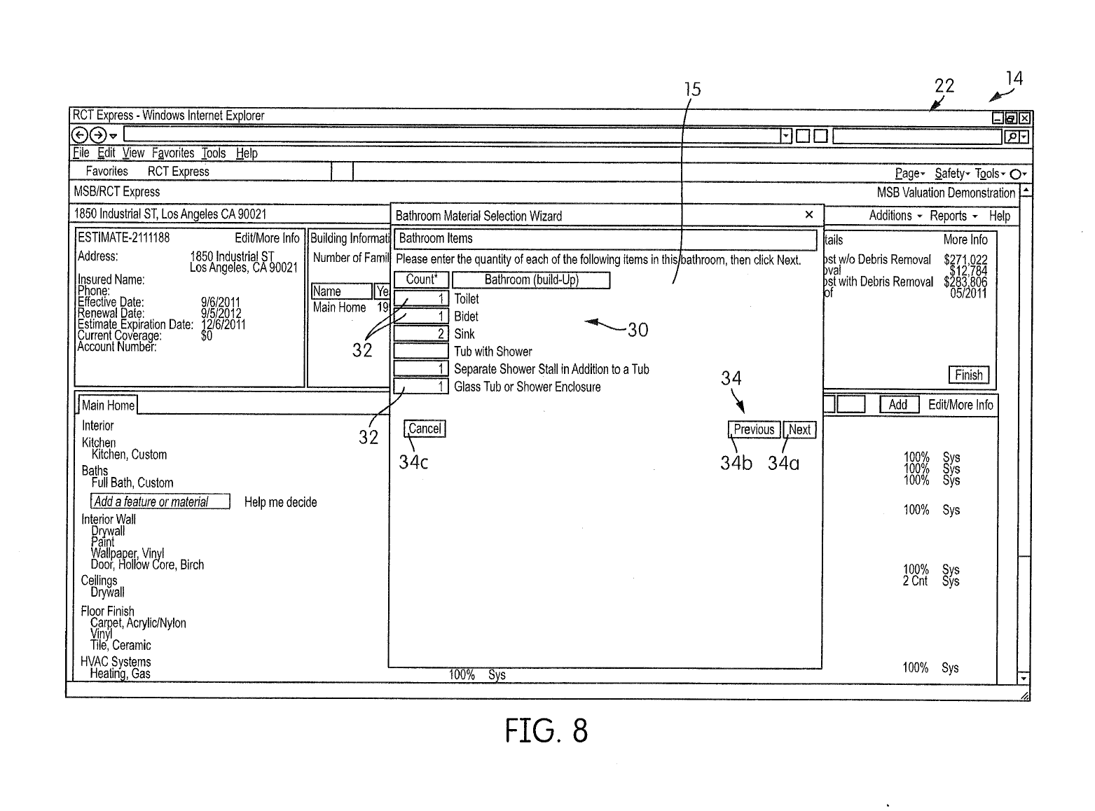

FIG. 8 shows a screenshot of the webpage 15 displaying queries 30 associated with bathroom structures or accessories. The type of accessories or structures and/or the number of accessories or structures may define the quality indicators. The webpage 15 includes input fields 32 configured to enable users to input information therein using the user interface device. In this embodiment, each accessory or feature includes an input field 32 associated therewith. The button 34b may be selected to view the webpage 15 with the contents shown in FIG. 7.

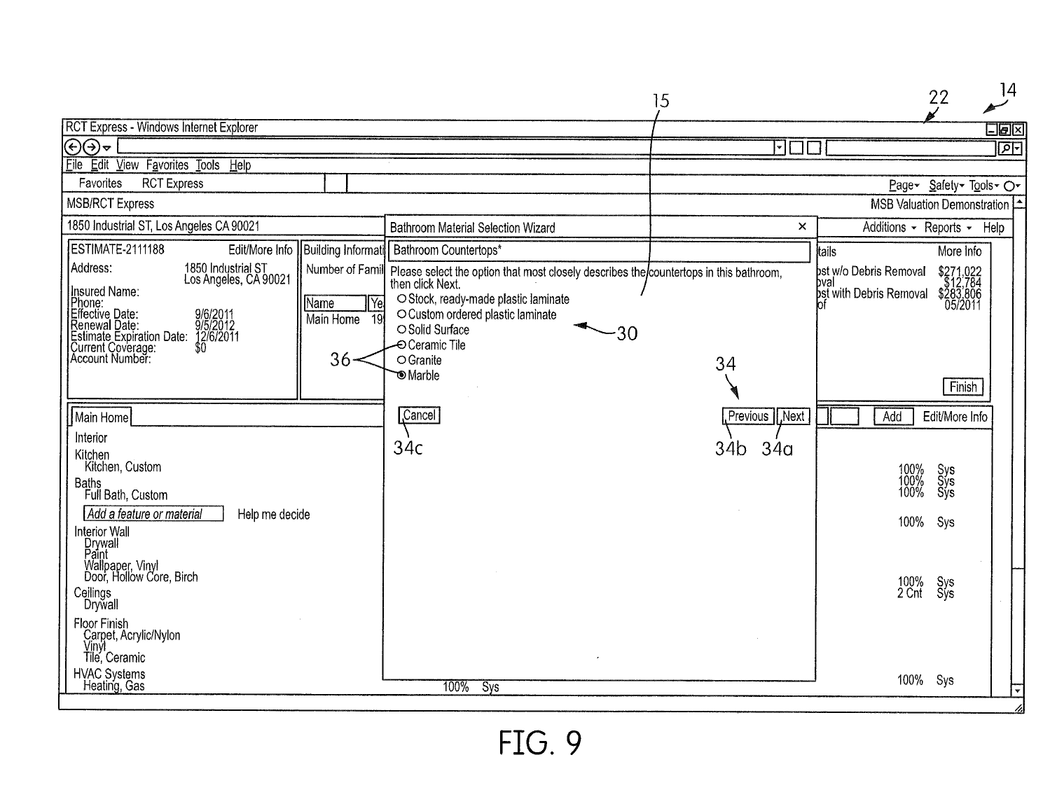

FIG. 9 shows a screenshot of the webpage 15 displaying queries 30 associated with countertop material. In this embodiment, each material may be a quality indicator. In this embodiment, the webpage 15 includes a radio button 36 associated with each countertop material. However, it should be appreciated other input fields or types may be used. It should also be appreciated that the type of materials listed may vary in other embodiments. The button 34b may be selected to view the webpage 15 with the contents shown in FIG. 8.

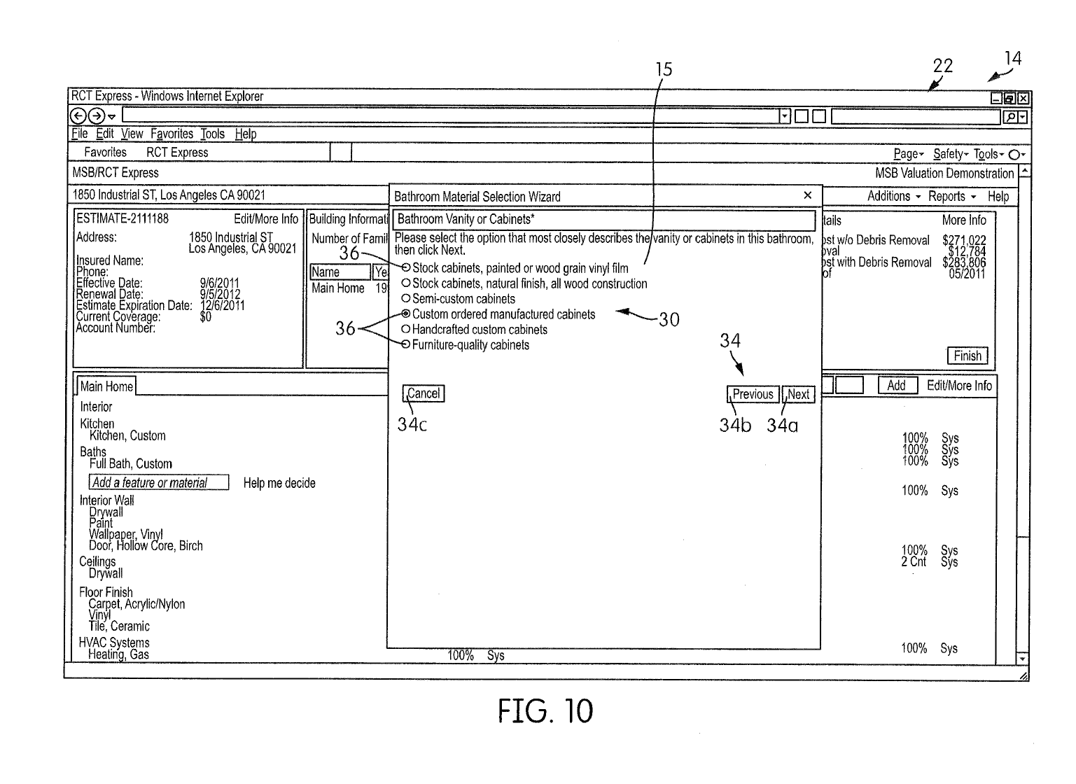

FIG. 10 shows a screenshot of the webpage 15 displaying queries associated with vanity or cabinet material. In this embodiment, each material may be a quality indicator. In this embodiment, the webpage 15 includes a radio button 36 associated with each vanity or cabinet material. However, it should be appreciated other input fields or types may be used. It should also be appreciated that the type of materials listed may vary in other embodiments. The button 34b may be selected to view the webpage 15 with the contents shown in FIG. 9.

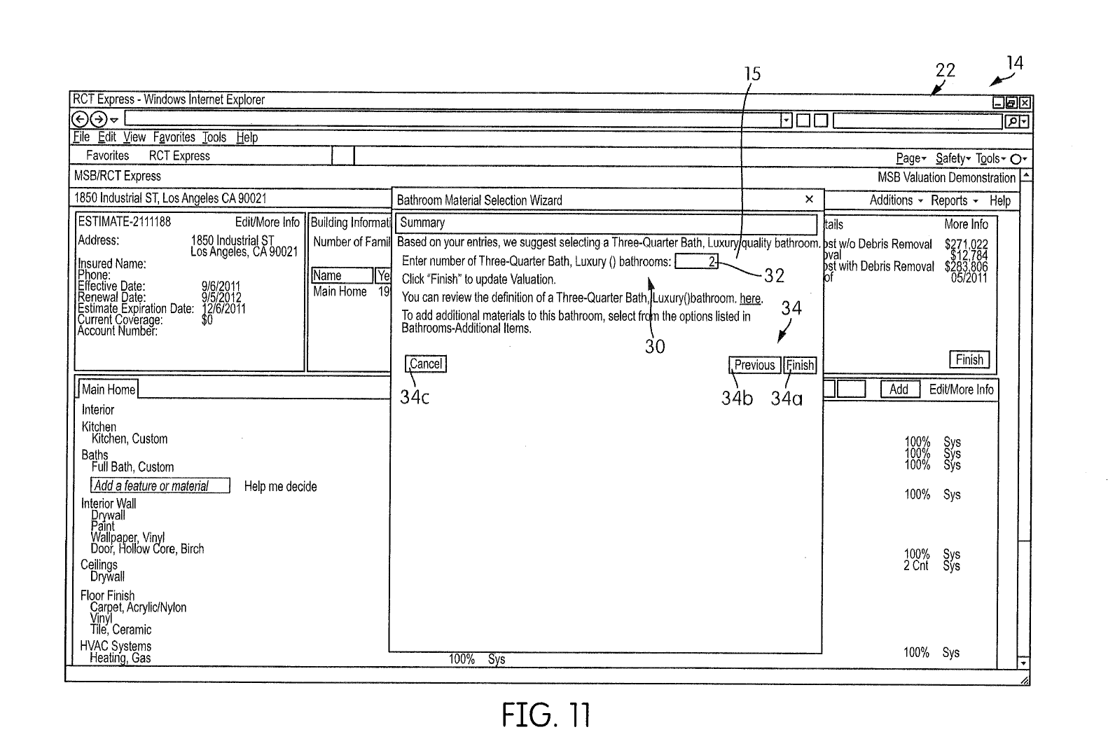

FIG. 11 shows a screenshot of the webpage 15 displaying the quantity level of the bathroom based on the quality indicators entered by the user in the webpages 15 shown in FIGS. 7-10. The quality level may be determined by the server system 12 based on the bathroom quality data received from the user computer 14. The quality level may be transmitted to the user computer 14 via the network for display on the webpage 15, which will be described in more detail later. FIG. 11 includes an input field 32 wherein a user may enter the number of bathrooms having the quality level. The button 34b may be selected to view the webpage 15 with the contents shown in FIG. 10. A link may be provided such that selection of the link effects the information or details of the quality level to be displayed via the web browser 22. The information or details may be transmitted from the server system 12 to the user computer 12 for display using the web browser 22.

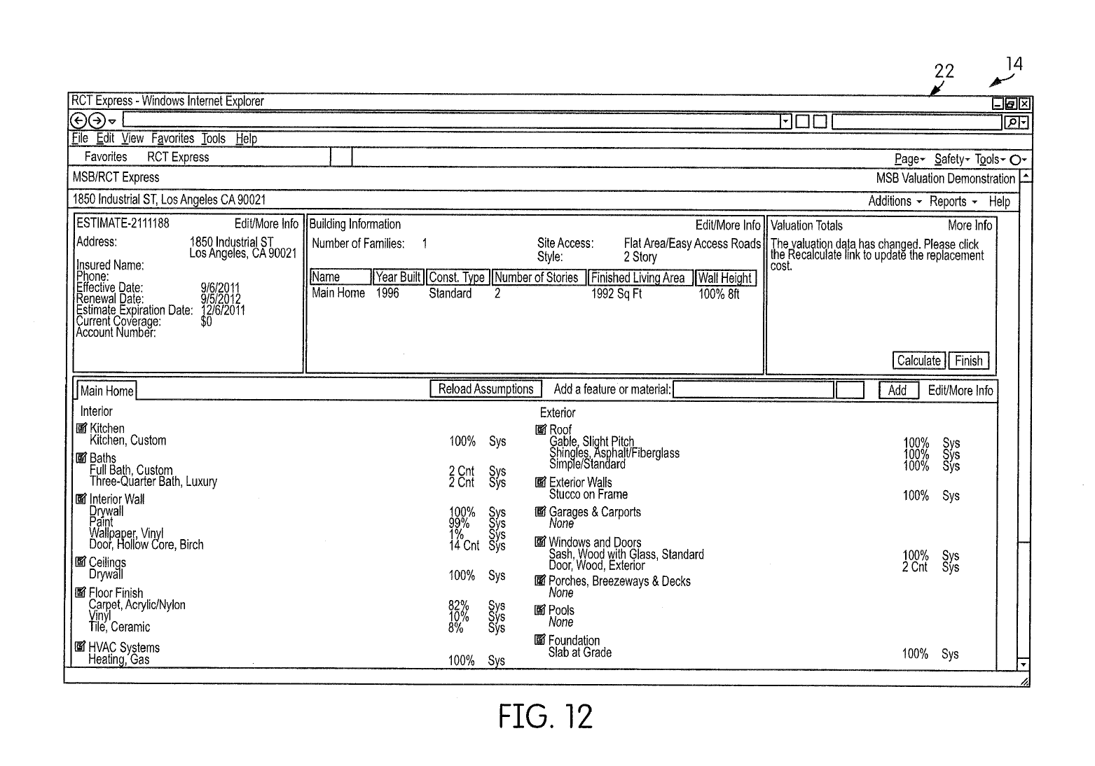

FIG. 12 shows a screenshot of the webpage 15 with the quality level of the bathrooms and/or kitchens and the number of such bathrooms/kitchens displayed. The user may interact with this webpage to start the valuation method for determining the quality levels of bathrooms and/or kitchens.

As mentioned above, the server system 12 is configured to receive quality data from the user computer 14 entered by the user via the webpage 15 displayed on the web browser 22. The data is transmitted over the network 16 to the server system 12. The server system 12 processes the data and determines the quality level of the kitchen and/or bathroom and transmits the quality level and other data to the user computer 14 for display on the webpage 15.

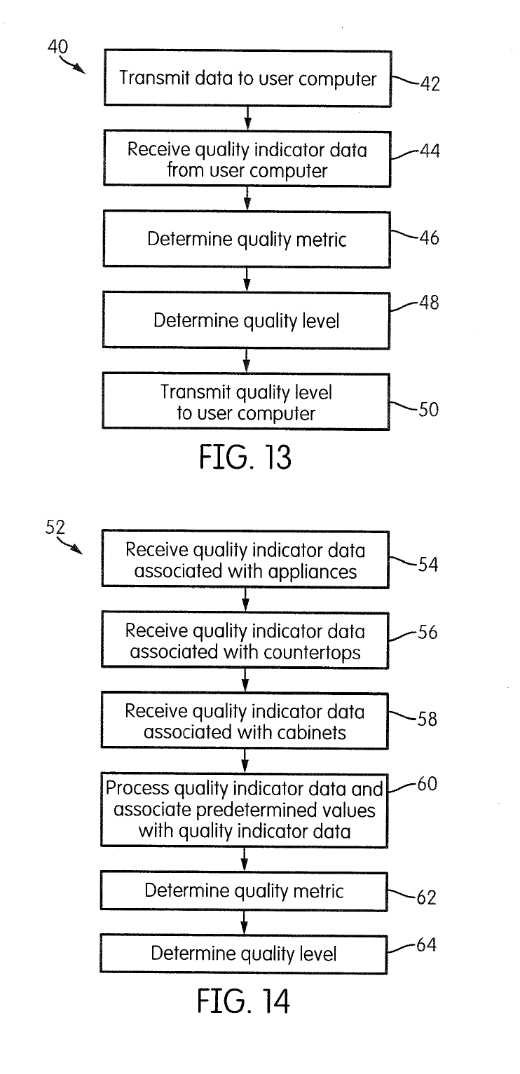

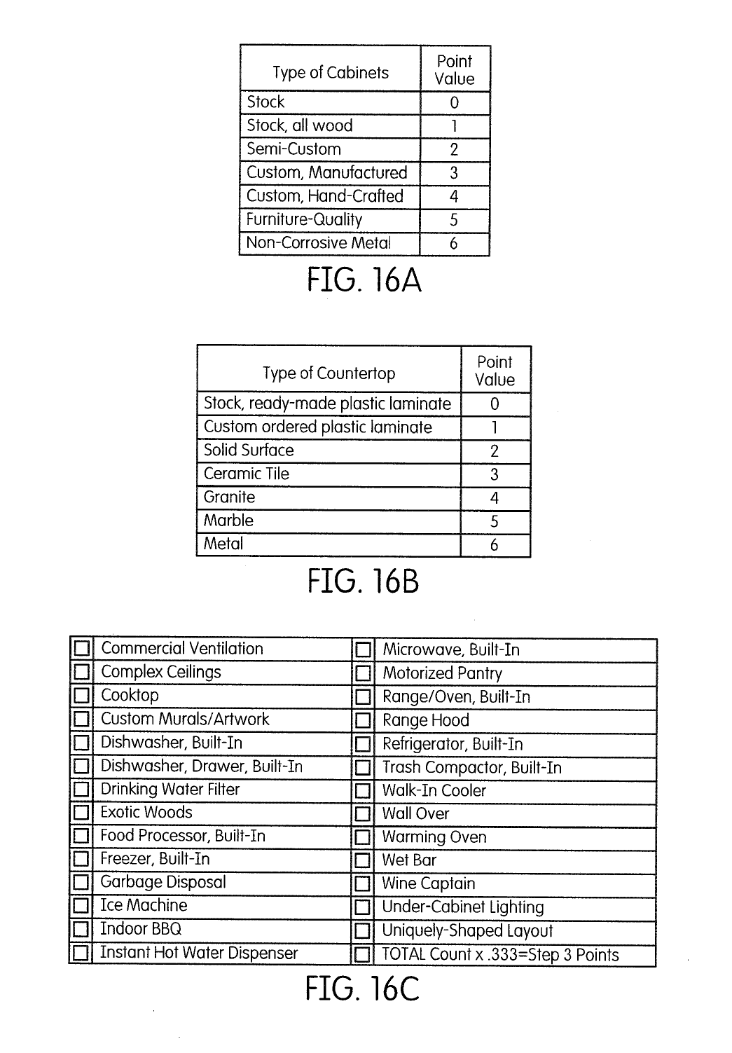

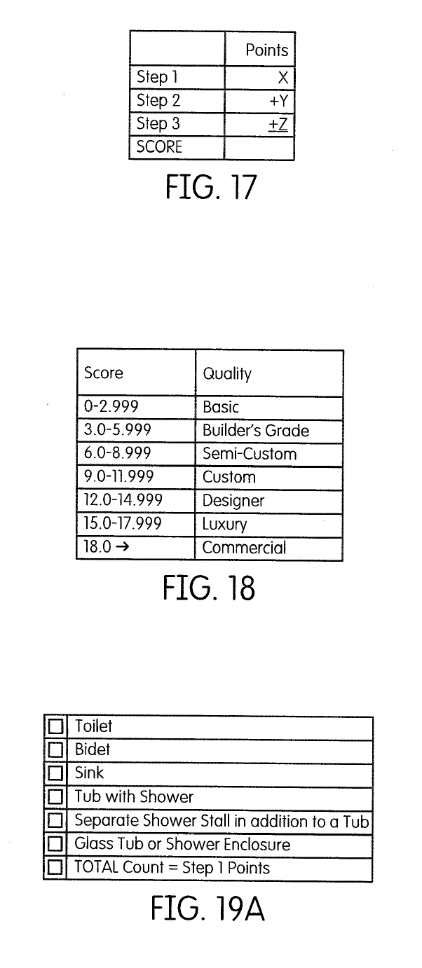

As mentioned above, in one embodiment, the user computer 14 receives the quality level from the server system 12 of the valuation system 10. The valuation system 10 may valuate the quality level according to process 40 shown in FIG. 13 in accordance with an embodiment. It should be appreciated that this process 40 is not intended to be limiting, and operations may be added or eliminated from the process 40. The process 40 may start with operation 42 wherein data (e.g., data relating to the content of the webpage 15) are transmitted from the server system 12 to the user computer 14 for display using the web browser 22. In some embodiments, data may be transmitted using the front end system 24 that includes the http server module 26 and the web application server module 28. This data may be transmitted in response to a user selection or input relating to the access of webpage 15. For example, the user may enter an http address or select a link so that data is transmitted from the server system 12 to the user computer 14 over the network 16. The webpage 15 (for example, any of the webpages 15 shown in FIGS. 3-12) may be displayed to the user using the user computer 15 and the user may then input data as described above. The quality indicator data is transmitted by the user computer 14 to the server system 12 over the network 16. The process 40 then proceeds to operation 44 wherein the server system 12 receives the quality indicator data from the user computer 14 over the network 16. The quality indicator data may be saved in the data repository 18 of the system 10. The process 40 then proceeds to operation 46 wherein the quality metric is determined based on the quality indicator data received from the user computer 14. In this operation, the system 10 may access the data repository 18 or other memory to access a matrix, chart, tables, or other association between quality indicators and predetermined values associated with the quality indicators. The predetermined values associated with the quality indicators are shown in the exemplary tables of FIGS. 16A-16C, 19A-19C, and 21A-21B, which will be described in more detail later. The system 10 may add predetermined values associated with quality indicators to arrive at the quality metric value or score, for example, as shown in the tables of FIGS. 17, 20 and 22, which will be described in more detail later. In some embodiments, the process module 20 may be configured to determine the quality metric. After determining the quality metric, the process 40 then proceeds to operation 48 wherein the quality level is determined. In this embodiment, the system 10 may access the data repository or other memory to associate the quality metric or score determined in operation 46 with a quality level. In some embodiments, a table, matrix, chart, or other associations between the quality score or metric and the quality level, for example, the tables shown in FIGS. 18 and 23 may be used. In some embodiments, the process module 20 of the server system 12 may be used to perform this operation 48. The process 40 then proceeds to operation 50 wherein the quality level is transmitted to the user computer 14 for display on the webpage 15 using the web browser 22 (for example, as shown in FIGS. 6 and 11).

The valuation of a kitchen quality level is described in process 52 shown in FIG. 14 in accordance with an embodiment. As shown in FIG. 14, the process 52 starts with operation 54 wherein quality indicator data associated with appliances is received from the user computer 14. As described above, FIG. 3 shows a screenshot of an exemplary webpage 15 that displays the queries 30 associated with kitchen appliances to the user using the web browser 22. After the user has inputted data into the webpage 15, the data is then transmitted to the server system 12 and is received by the server system 12. The process 52 may then proceed to operation 56 wherein quality indicator data associated with countertops are received from the user computer 14. As described above, FIG. 4 shows a screenshot of an exemplary webpage 15 that displays the queries associated with kitchen countertops to the user using the web browser 22. After the user has inputted data into the webpage 15, the data is then transmitted to the server system 12 and is received by the server system 12. The process 52 then proceeds to operation 58 wherein quality indicator data associated with cabinets are received from the user computer 14. As described above, FIG. 5 shows a screenshot of an exemplary webpage 15 that displays the queries 30 associated with kitchen cabinets to the user using the web browser 22. After the user has inputted data into the webpage 15, the data is then transmitted to the server system 12 and is received by the server system 12. The process then proceeds to operation 60 wherein the quality indicator data are processed and the quality indicator data are then associated with predetermined values. It should be appreciated that operation 60 may be performed after each operation 54, 56, 58 has been performed or may be performed after all the operations 54, 56, 58 have been performed. In some embodiments, in operation 60, the process module 20 may access the data repository or other memory to access the tables, charts, matrix or other associations to determine the associations between the quality indicators and the predetermined values. For example, the table in FIG. 16A may be used to associate quality indicators relating to cabinet types with predetermined values (i.e., point values). Thus, the quality indicator data received from the user computer 14 relating to kitchen cabinet may be associated with its predetermined value shown in the table of FIG. 16A. The table in FIG. 16B may be used to associate quality indicators relating to countertop material with predetermined values (i.e., point values). Thus, the quality indicator data received from the user computer 14 relating to countertop material may be associated with its predetermined value shown in the table of FIG. 16B. Furthermore, the table in FIG. 16C associates each feature or appliance of the kitchen with a point value (e.g., 1 point) such that each instance of a feature or appliance can be used towards the determination of a quality metric (e.g., a quality score). In some embodiments, each instance of an appliance or feature may be added together and the total may be multiplied by a constant (e.g., 0.333) to be used towards the calculation of the quality metric or score. The process 52 proceeds to operation 62 wherein a quality metric or score of the kitchen is determined. The quality metric may be determined by adding the predetermined values of the quality indicators determined in operation 60. For example, the predetermined values as determined using the tables in FIG. 16A, FIG. 16B, and FIG. 16C may be added together. The process 52 then proceeds to operation 64 wherein a quality level of the kitchen is determined. The quality level may be based on the quality metric determined in operation 62. In one embodiment, charts, tables, or other associations, such as the table shown in FIG. 18, may be used to determine the quality level based on the quality metric or score. In some embodiments, any or all of the operations of the process 52 may be performed by process module 20 of the server system 12. As an example, in one embodiment, a kitchen having “stock, all wood” cabinet, “solid surface countertop,” and a cook top, a dishwasher, and an ice machine may have a quality metric or score of 4. That is, the “stock, all wood” may be associated with a predetermined value of 1, the “solid surface countertop” may be associated with a predetermined value of 2, and the cook top, dishwasher, and ice machine may have a value of 1 (three counts multiplied by the constant of 0.333). In such an example, the quality level would be a “builder's grade” as determined using the table of FIG. 18. The quality level of the kitchen determined using process 52 may be transmitted to the user computer 14 for display on the webpage 15, as described above.

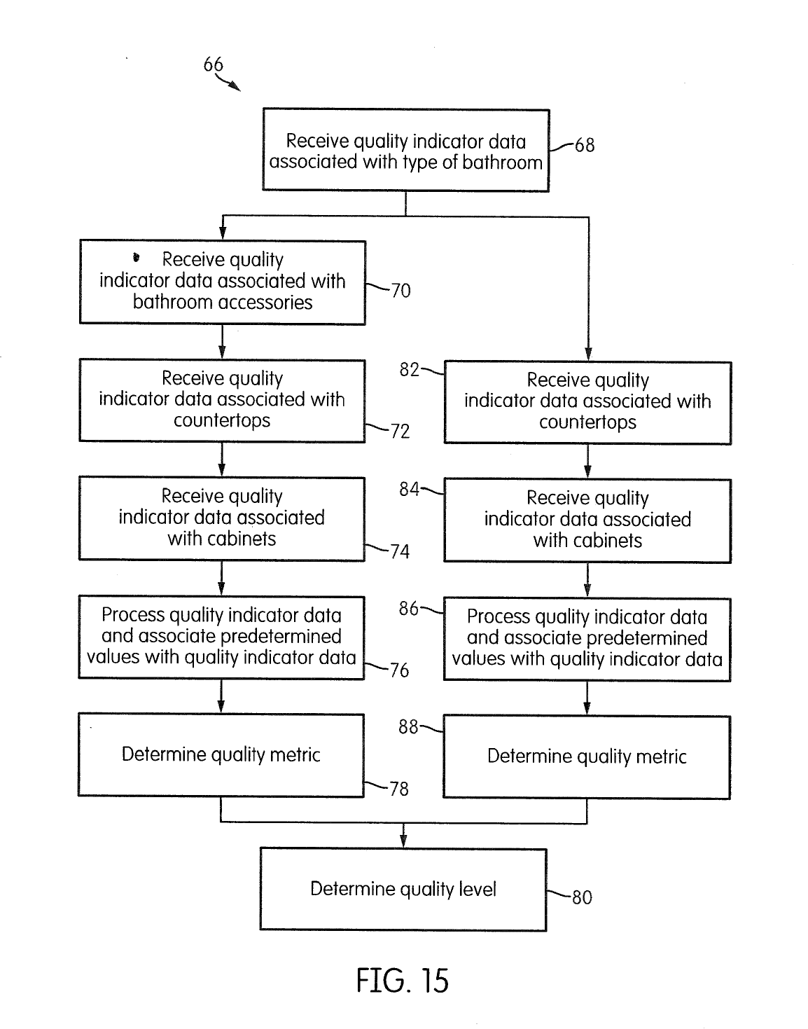

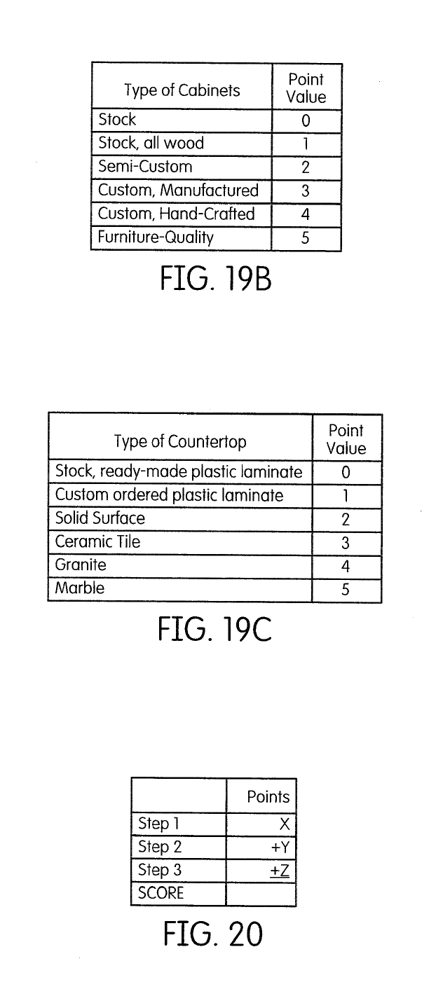

The valuation of a bathroom quality level is described in process 66 shown in FIG. 15 in accordance with an embodiment. As shown in FIG. 15, the process 66 starts with operation 68 wherein quality indicator data associated with the type of bathroom is received from user computer 14. As described above, FIG. 7 shows a screenshot of an exemplary webpage 15 that displays the queries 30 associated with bathroom types to the user using the web browser 22. After the user has inputted data into the webpage 15, the data is then transmitted to the server system 12 and is received by the server system 12. If the user inputs a full or ¾ bathroom selection, the process 66 proceeds to operation 70 wherein the quality indicator data associated with bathroom accessories is received from the user computer 14. Accordingly, if the selected bathroom type is a full or ¾ bathroom, the screenshot of the webpage 15 displayed to the user may be similar to the one shown in FIG. 8. The user may then input data into the webpage 15 and the quality indicator data may then be transmitted to the server system 12 and received by the server system 12. The process 66 may then proceed to operation 72 wherein quality indicator data relating to countertops is received from the user computer 14. As described above, FIG. 9 shows a screenshot of an exemplary webpage 15 that displays the queries 30 associated with bathroom countertops to the user using the web browser 22. After the user has inputted data into the webpage 15, the data is then transmitted to the server system 12 and is received by the server system 12. The process 66 then proceeds to operation 74 wherein quality indicator data associated with cabinets are received from the user computer 14. As described above, FIG. 10 shows a screenshot of an exemplary webpage 15 that displays the queries 30 associated with bathroom cabinets to the user using the web browser 22. After the user has inputted data into the webpage 15, the data is then transmitted to the server system 12 and is received by the server system 12. The process 66 then proceeds to operation 76 wherein the quality indicator data is processed and the quality indicator data received from the user computer 14 is associated with predetermined values. For example, the table in FIG. 19A may be used to associate each feature or accessory of the bathroom with a point value (e.g., 1 point) such that each instance of a feature or accessory can be used towards the determination of a quality metric (e.g., a quality score). Each instance of a feature or accessory may be considered one point. The table in FIG. 19B may be used to associate quality indicators relating to cabinet types with predetermined values (i.e., point values). Thus, the quality indicator data received from the user computer 14 relating to bathroom cabinet may be associated with its predetermined value shown in the table of FIG. 19B. The table in FIG. 19C may be used to associate quality indicators relating to countertop material with predetermined values (i.e., point values). Thus, the quality indicator data received from the user computer 14 relating to countertop material may be associated with its predetermined value shown in the table of FIG. 19C. The process 66 proceeds to operation 78 wherein a quality metric or score of the bathroom is determined. The quality metric may be determined by adding the predetermined values of the quality indicators determined in operation 76, for example, as shown in FIG. 20. For example, the predetermined values as determined using the tables in FIGS. 19A-19C may be added together. The process 66 then proceeds to operation 80 wherein a quality level of the bathroom is determined. The quality level may be based on the quality metric determined in operation 78. In one embodiment, charts, tables, or other associations, such as the table shown in FIG. 23, may be used to determine the quality level based on the quality metric or score. In some embodiments, any or all of the operations of the process 66 may be performed by process module 20 of the server system 12. As an example, in one embodiment, a full sized bathroom having a toilet, a bidet, a sink, a tub with shower, “semi-custom” cabinets, and “solid surface” countertops may have a quality metric or score of 8. That is, the “semi-custom” cabinets may be associated with a predetermined value of 2, the “solid surface countertop” may be associated with a predetermined value of 2, and the toilet, bidet, sink, and tub with shower may have a value of 4 (one point for each instance). In such an example, the quality level would be a “semi-custom” as determined using the table of FIG. 23. The quality level of the bathroom determined using process 66 may be transmitted to the user computer 14 for display on the webpage 15, as described above.

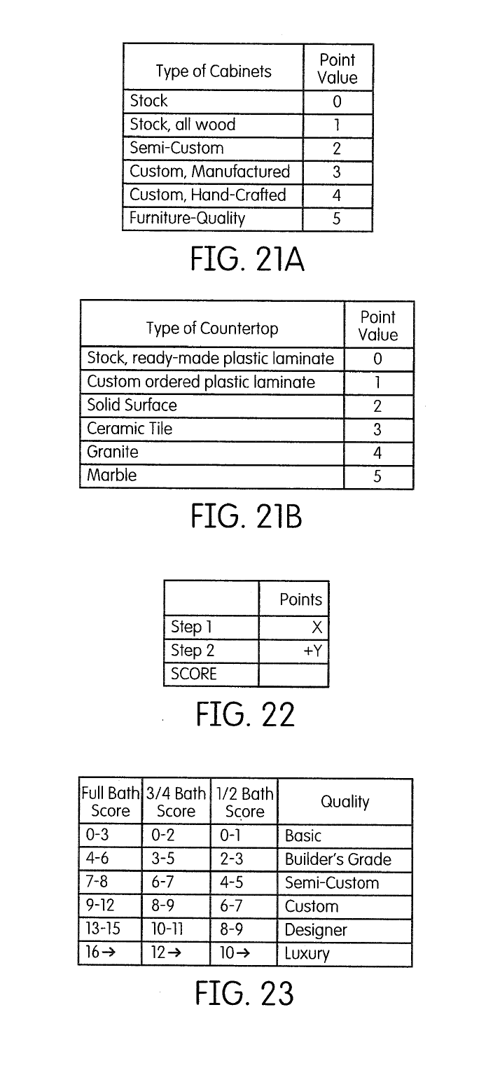

Referring back to operation 68, if the user selection is a half bathroom, the process 68 would proceed to operation 82 wherein quality indicator data associated with countertops is received from the user computer 14. Operation 82 may be similar to operation 72. The process 66 may then proceed to operation 84 wherein quality indicator data associated with cabinets is received from the user computer 14. Operation 84 may be similar to operation 74. The process 66 may then proceed to operation 86 wherein quality indicator data is processed and the predetermined values are associated with quality indicator data. For example, the table shown in FIG. 21B may be used to associate the predetermined values with the quality indicator data relating to countertops, and the table shown in FIG. 21A may be used to associate the predetermined values with the quality indicator data relating to cabinets. The process 66 proceeds to operation 88 wherein a quality metric or score of the bathroom is determined. Operation 88 may be similar to operation 78 and the quality metric may be determined by adding the predetermined values of the quality indicators determined in operation 86, for example, as shown in FIG. 22. For example, the predetermined values as determined using the tables in FIGS. 21A-21B may be added together. The process 66 then proceeds to operation 80 wherein a quality level of the bathroom is determined, as described above. The quality level may be based on the quality metric determined in operation 88. In one embodiment, charts, tables, or other associations, such as the table shown in FIG. 23, may be used to determine the quality level based on the quality metric or score.

It should be appreciated that any of the operations of the processes described above may occur in any order and may include additional operations. It should also be appreciated that some of the operations may be combined and/or may be defined by multiple operations occurring at different times or concurrently.

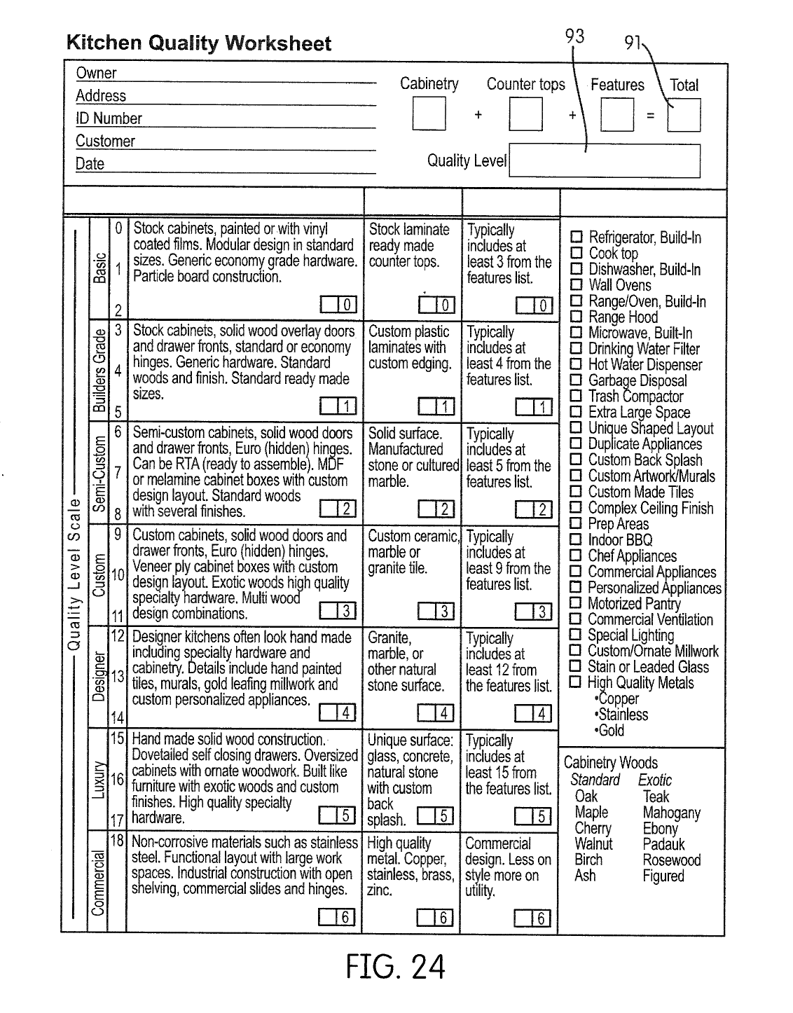

FIG. 24 shows a table of the quality levels of the kitchen in more detail. As shown, each of the quality levels is based on the types of cabinets, countertops, and other features of the kitchen. It is contemplated that the predetermined values and/or quality indicators may vary in other embodiments. The features (e.g., accessories, materials) and the predetermined values (e.g., point values) shown in FIG. 24 may be included in the quality valuation system 10. That is, the quality valuation system 10 may be configured to determine a kitchen quality level according to the features and predetermined values shown in FIG. 24. In some embodiments, for example the ones described above, the quality valuation system 10 determines the quality levels based on the information provided in FIG. 24 using a combination of software and hardware (e.g., computing devices, networks, and processors). Also shown in FIG. 24 are boxes 91 and 93. Box 91 may be associated with a quality metric as described above. Box 93 may be associated with the quality level based on the quality metric using the quality level table shown in FIG. 24.

As shown in FIG. 24, choices of cabinetry include stock cabinets, semi-custom cabinets, custom-manufactured cabinets, custom hand-crafted cabinets, furniture-quality cabinets, and non-corrosive cabinets. The “stock cabinet” may be referred to as “box” or “bare bones” cabinetry. Example descriptions of these cabinets are as follows. Stock cabinets are mass-produced and warehoused rather than being built to unique specifications. These cabinets are manufactured to industry size standards. Stock cabinetry widths begin at 9 inches and increase in 3″ increments to 48″, the largest standard size available. Individual components are selected from a list of available units, and “assembled” to create the desired layout. Since a kitchen's dimensions may not correspond to the available increments; starters, filler strips and end caps are used to close gaps between cabinets, walls and/or appliances. Stock cabinets usually offer limited choices of wood species, door styles, accessories and finishes. Stock cabinets can be made of wood products such as particle board or medium density fiberboard (MDF), which is covered with factory-applied paint or vinyl photographs of wood grain patterns. Alternatively, stock cabinets can be of the all-wood variety, albeit hardwood veneered softwood might be used in place of solid stock. Painted cabinetry does not necessarily indicate stock cabinets, as high-end cabinetry may be painted to complement the particular style or motif of a residence.

“Semi-custom” cabinet is a full cut above stock cabinetry and offer more flexibility. Although they are not built to the exact requirements of a particular kitchen, with components being selected from a list of standard sizes, semi-custom cabinets are typically not manufactured until the order is received. With semi-custom cabinets; fewer limitations are encountered, more sizes and styles are offered, and many more custom features are available.

“Custom-manufactured” cabinets are factory-produced per the detailed plans and specification provided (i.e., instead of selecting components from a stock list, each piece is sized according to the dimensions of the specific kitchen). Custom cabinet manufacturers can provide almost any size cabinet, and offer many, many styles, material choices, and finishes.

“Custom, hand-crafted” cabinets are usually built by a local cabinet/woodworking shop that employs experienced, highly-skilled craftsmen. This cabinetry is often very unique and designed to meet the requirements of the homeowner. Like custom manufactured cabinets, any size cabinet is possible. Non-corrosive metal may include stainless steel, zinc, copper, brass, or other metals.

The types of countertop material may include stock plastic laminate, custom plastic laminate, solid surface, ceramic marble or granite tile, natural stone (e.g., granite, marble), unique surface (e.g., glass, concrete, natural stone with custom backsplash), and high quality metal (e.g., copper, stainless, brass, zinc). “Plastic laminate” is a heat and chemical-resistant surface made by using high-pressure to laminate plastic sheets of synthetic resin, and often referred to by their trademarks (e.g., Formica®, Wilsonart®, Nevamar®). Stock (also known as a post-formed or ready-made) plastic laminate countertop is a mass-produced, prefabricated top that typically consists of one to three bends in the laminate (tri-cove is a popular style), which has been adhered to a substrate. Post-formed countertops are “stock” items and usually sold in standard lengths of 3′ to 12′, in 1 foot increments. The laminate may include accessories such as mitered corners and end caps. “Custom plastic laminate” is typically fabricated for a specific application. The color, style of edge treatments, wood edges, and inlaid color accents may vary. “Solid surface” is a non-porous countertop material consisting of acrylic or polyester resins and color granules. It is commonly referred to by the trademarks Corian®, Avonite®, Swanstone®, and others.

As shown in FIG. 24, there may be features associated with the kitchens. For example, the kitchens may have complex ceilings (e.g., tray, tiered, vaulted, coffered, ornamental, luminous), custom murals/artwork, exotic woods (e.g., teak, mahogany, ebony, padauk, rosewood, figured woods), uniquely-shaped layouts (e.g., walls and/or cabinets at angles other than 90 degrees relative to one another), and other features.

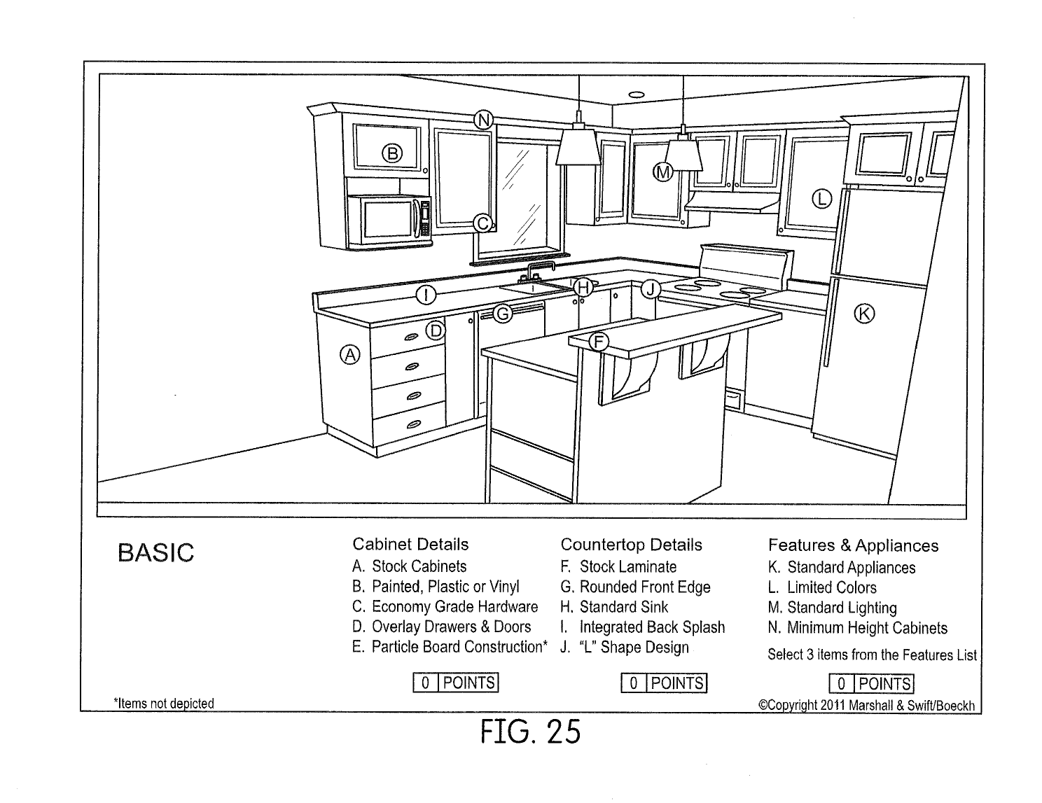

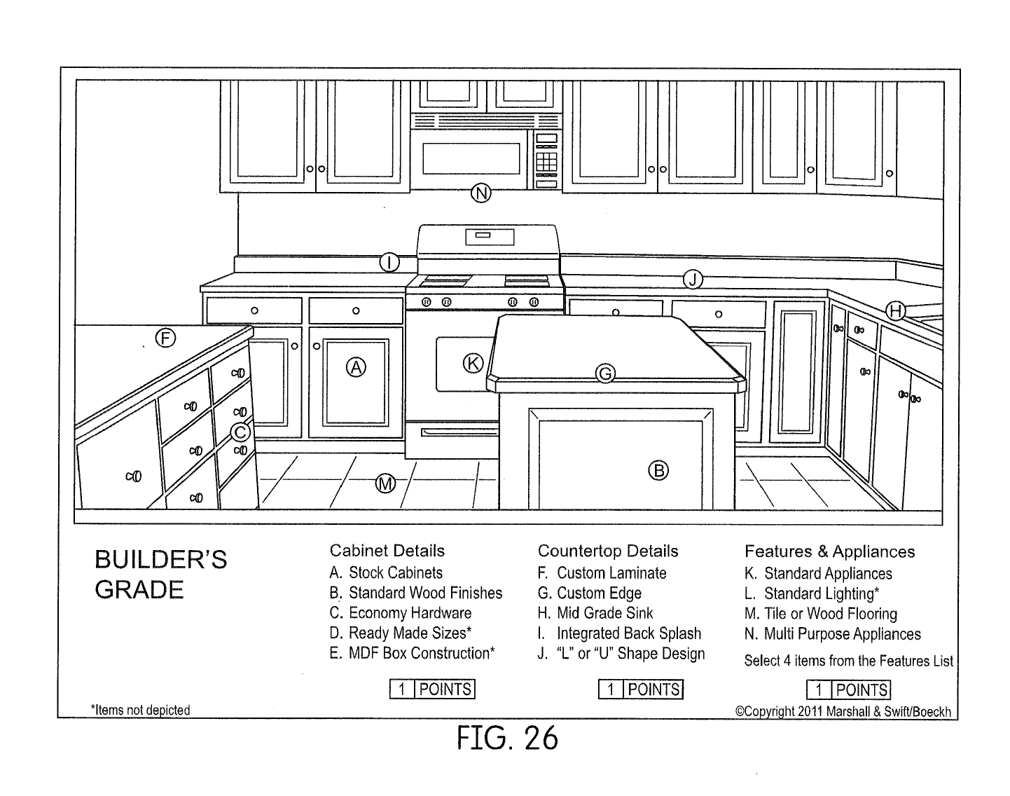

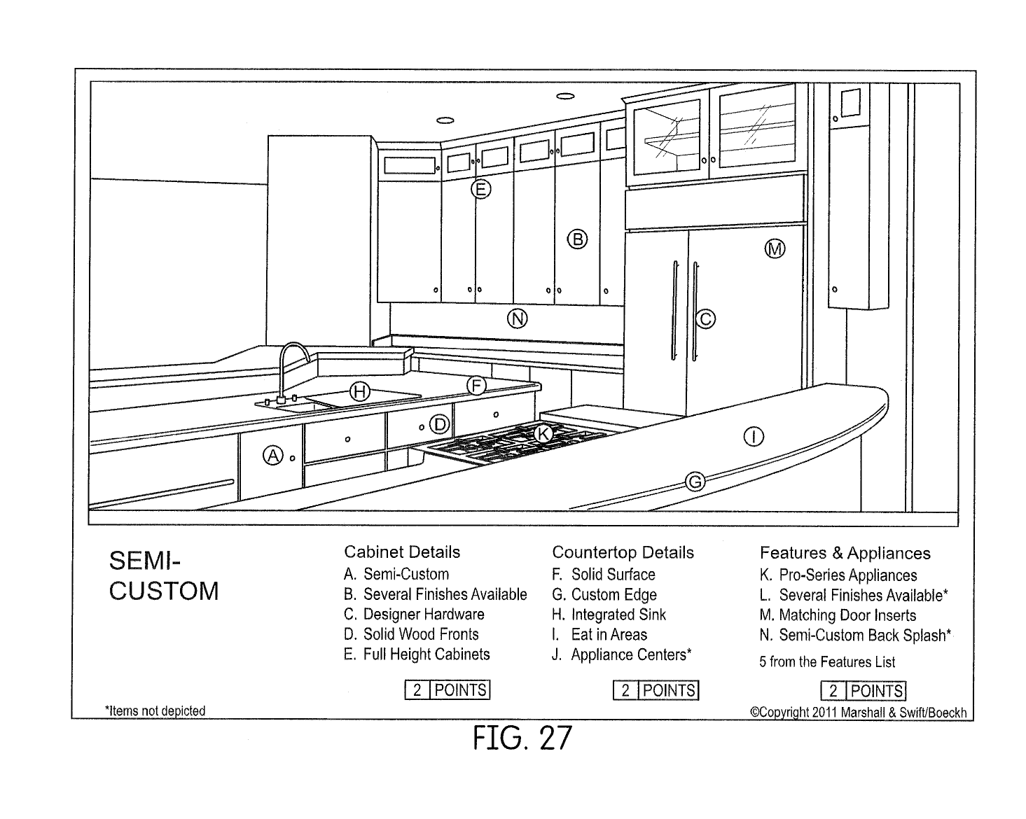

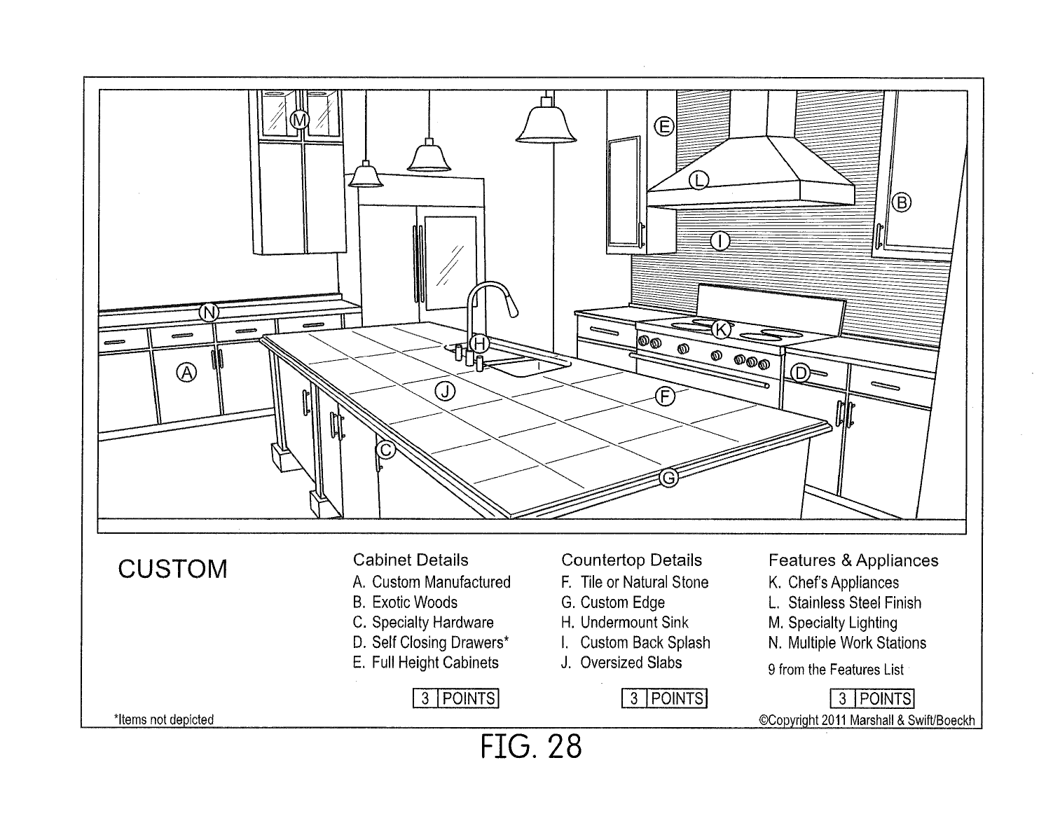

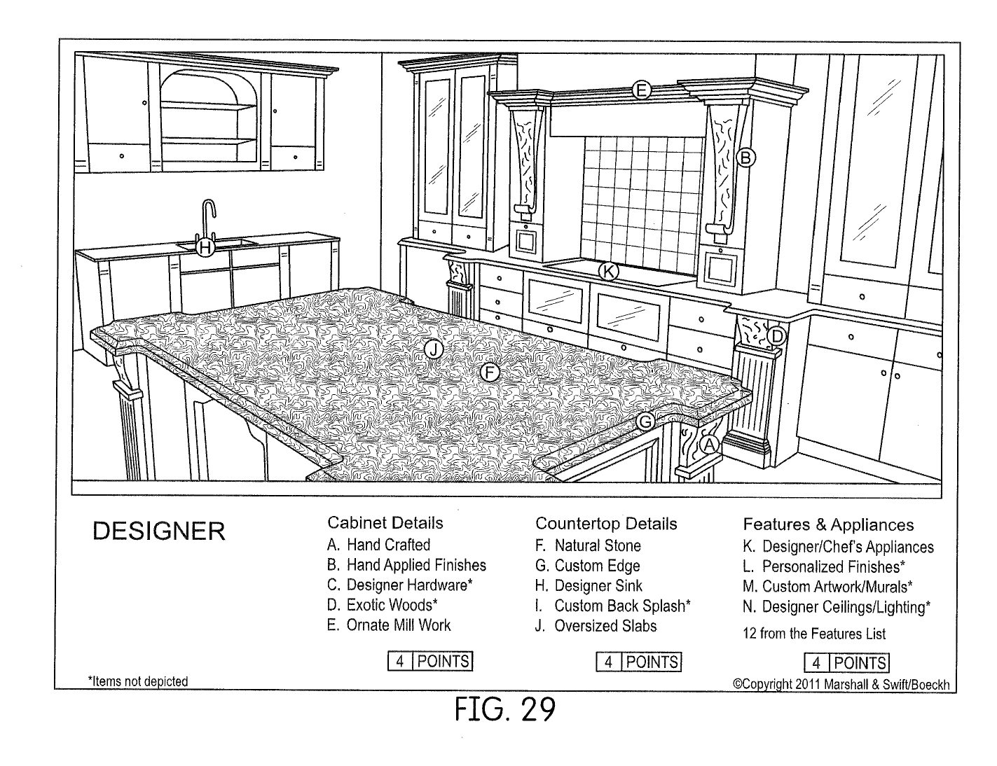

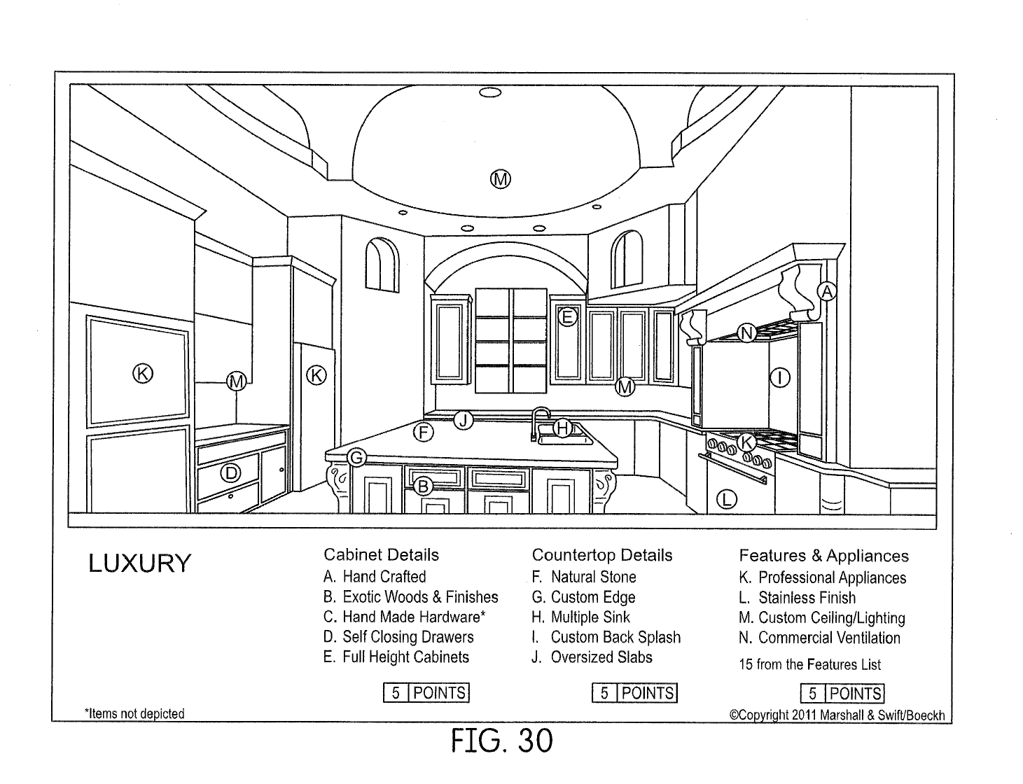

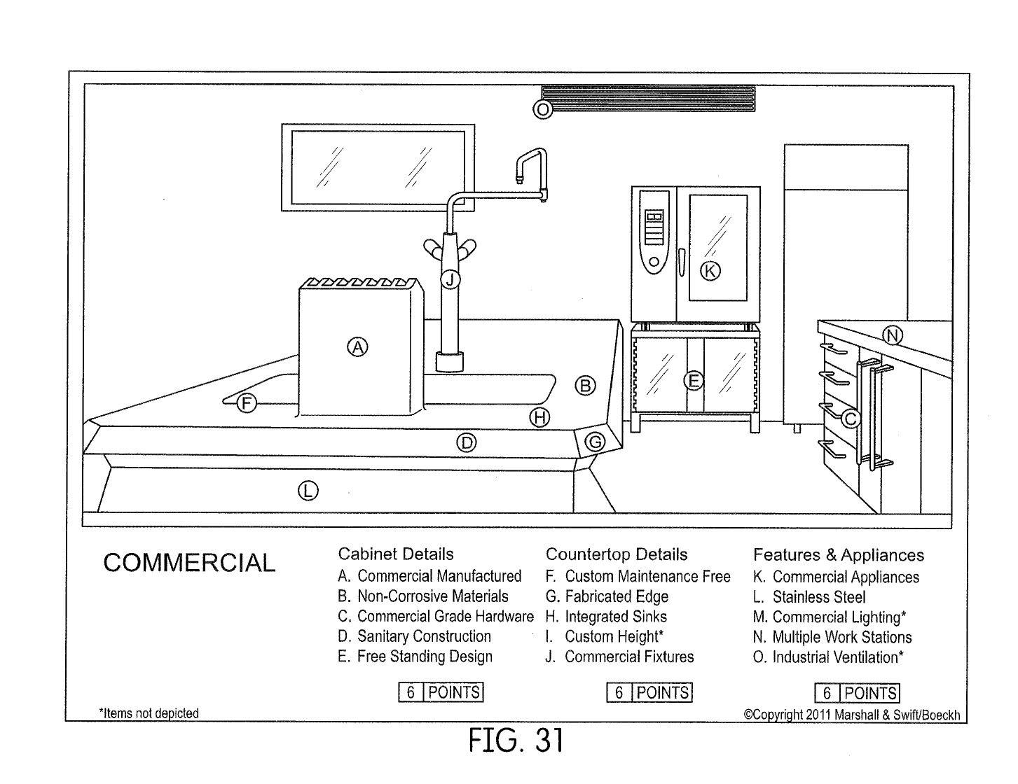

FIG. 25 illustrates exemplary features of a kitchen having a quality level of “basic.” FIG. 26 illustrates exemplary features of a kitchen having a quality level of “builder's grade.” FIG. 27 illustrates exemplary features of a kitchen having a quality level of “semi-custom.” FIG. 28 illustrates exemplary features of a kitchen having a quality level of “custom.” FIG. 29 illustrates exemplary features of a kitchen having a quality level of “designer.” FIG. 30 illustrates exemplary features of a kitchen having a quality level of “luxury.” Finally, FIG. 31 illustrates exemplary features of a kitchen having a quality level of “commercial.”

It should be appreciated that the quality indicators may vary in other embodiments. Just for example, in one embodiment, there might be no “basic” quality level. In another embodiment, the equivalent of “basic” may be available, but different terminology may be used to describe that same level. In another embodiment, the quality level may be numeric, such as “Quality Level 1”, “Quality Level 2”, etc.

In another embodiment, additional quality indicators may be provided (in addition to the ones indicated herein). For example, additional or alternative quality indicator data options for bathroom and/or kitchen may include hardware (fixtures, faucets, handles, heated towel bars, etc.), wall finishes, millwork, etc. Also, other additional or alternative quality indicator data options for bathroom may include toilets, showers, baths (e.g., high end (luxury or custom) vs. low end (basic or generic)).

The system of the present application may also provide an option for varying quality ranking within a specific category. For example, when the kitchen countertop material is being considered as the quality indicator, an option for varying quality ranking within the kitchen countertop material may be provided. That is, “new granite” may be provided with a ranking of 4, while “old (chipped) granite may be provided the ranking of 3, and so on.

Furthermore, the valuation system 10 may not be limited to valuating the quality level of the kitchen and/or bathroom, and may be used to valuate the quality level of other rooms, structures, buildings, or dwellings.

Embodiments of the invention may be made in hardware, firmware, software, or various combinations thereof. The invention may also be implemented as instructions stored on a machine-readable medium, which may be read and executed using one or more processing devices. In one embodiment, the machine-readable medium may include various mechanisms for storing and/or transmitting information in a form that can be read by a machine (e.g., a computing device). For example, a machine-readable storage medium may include read only memory, random access memory, magnetic disk storage media, optical storage media, flash memory devices, and other media for storing information. While firmware, software, routines, or instructions may be described in the above disclosure in terms of specific exemplary aspects and embodiments performing certain actions, it will be apparent that such descriptions are merely for the sake of convenience and that such actions in fact result from computing devices, processing devices, processors, controllers, or other devices or machines executing the firmware, software, routines, or instructions.

The term “computer-readable medium” as used herein refers to any non-transitory medium that participates in providing instructions to the processor for execution. Such a medium may take many forms, including, but not limited to, non-volatile media and volatile media. Non-volatile media include, for example, optical or magnetic disks. Volatile media include dynamic memory. Common forms of computer-readable media include, for example, floppy disk, a flexible disk, hard disk, magnetic tape, any other magnetic medium, a Compact Disc Read Only Memory (CD ROM), Digital Video Disc (DVD) or any other optical medium, punch cards, paper tape, any other physical medium with patterns of holes, a Random Access Memory (RAM), a Programmable Read Only Memory (PROM), an Erasable Programmable Read Only Memory (EPROM), a Flash EPROM, any other memory chip or cartridge, or any other medium from which a computer can read. Various forms of computer-readable media may be involved in carrying one or more sequences of one or more instructions to the processor for execution.

It should be noted that in one embodiment, the quality metric need not be a numerical value that would be apparent to a user and may be “invisible” to the user. In another embodiment, the quality metric may indeed be apparent and made available to the user. In another embodiment, the quality level may be omitted, and/or the user may consider the quality metric to be a quality level. In another embodiment, the quality metric can be employed by the user to manually determine a quality level, rather than provide that functionality in the software.

In one embodiment, the quality level (or quality levels for multiple rooms) can be used as one factor in determining valuation for a house. Other factors may also be total living area, zip code, and other factors. These other factors may be put into a module in the software to facilitate home valuation.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A quality valuation system comprising:
a server system in communication with a user computer over a network;
a data repository operatively connected to the server system, the data repository storing quality indicator data relating to room quality indicators received from the user computer via the network,
the server system comprising one or more processors configured to:
communicate with the user computer through the network to display a webpage using the user computer and to receive the quality indicator data entered into the webpage in response to queries provided by the webpage;
determine a quality metric based on the quality data received from the user computer;
determine the quality level based on the quality metric;
communicate, through the network, the quality level to the user computer for display via the webpage.

2. The quality valuation system of claim 1, wherein the data repository further stores predetermined values associated with the room quality indicators.

3. The quality valuation system of claim 2, wherein the quality metric is determined based on the quality data received from the user computer and the predetermined values associated with quality indicators stored in the data repository.

4. The quality valuation system of claim 3, wherein the one or more processors of the server system is configured to add the predetermined values associated with the quality indicators when determining the quality metric.

5. The quality valuation system of claim 1, wherein the one or more processors is configured to access the data repository to determine the quality metric.

6. The quality valuation system of claim 1, wherein the webpage comprises input fields wherein data can be inputted in response to the queries provided by the webpage.

7. The quality valuation system of claim 1, wherein the quality indicators comprise at least one of the following: kitchen accessories, countertop material, cabinet material.

8. The quality valuation system of claim 1, wherein the server system comprises a web server system configured to transmit content of the webpage to the user computer through the network.

9. The quality valuation system of claim 1, wherein the quality indicators comprise at least one of the following: bathroom accessories, countertop material, cabinet material.

10. The quality valuation system of claim 1, wherein the one or more processors of the server system are further configured to transmit information relating to the quality level to the user computer for display via the webpage.

11. A method for evaluating a room quality level, the method comprising:
communicating, by a server system associated with a data repository, data to a user computer through a network to display a webpage via the user computer;
receiving, by the server system, quality indicator data entered into the webpage in response to queries provided by the webpage;
determining, by the server system, a quality metric based on the quality data received from the user computer;
determining, by the server system, the quality level based on the quality metric;
communicating, by the server system through the network, the quality level to the user computer for display via the webpage.

12. The method of claim 11, wherein the quality metric is determined based on the quality data received from the user computer and predetermined values associated with quality indicators stored in the data repository.

13. The method of claim 12, wherein determining the quality metric comprises adding the predetermined values associated with the quality indicators.

14. The method of claim 11, wherein determining the quality metric comprises accessing the data repository.

15. The method of claim 11, wherein the webpage comprises input fields wherein data can be inputted in response to the queries provided by the webpage.

16. The method of claim 11, wherein the quality indicators comprise at least one of the following: kitchen accessories, countertop material, cabinet material.

17. The method of claim 11, wherein the server system comprises a web server system configured to transmit content of the webpage to the user computer through the network.

18. The method of claim 11, wherein the quality indicators comprise at least one of the following: bathroom accessories, countertop material, cabinet material.

19. The method of claim 11, wherein further comprising transmitting information relating to the quality level to the user computer for display via the webpage.

20. A computer readable non-transitory medium storing computer executable instructions for evaluating a kitchen or bathroom quality level, the instructions when executed configuring one or more processors to:
communicate, by a server system associated with a data repository, data to a user computer through a network to display a webpage via the user computer;
receive, by the server system, quality indicator data entered into the webpage in response to queries provided by the webpage;
determine, by the server system, a quality metric based on the quality data received from the user computer;
determine, by the server system, the quality level based on the quality metric; and
communicate, by the server system through the network, the quality level to the user computer for display via the webpage.
